(19) United States
(12) Patent Application Publication
(10) Pub. No.: US 2010/0026009 A1
(43) Pub. Date: Feb. 4, 2010

(54) TURBINE APPARATUS

(76) Inventor: Herbert S. Sarwin, Millburn, NJ (US)

Correspondence Address: KATTEN MUCHIN ROSENMAN LLP, 575 MADISON AVENUE, NEW YORK, NY, 10022-2585, US

(21) Appl. No.: 12/509,550

(22) Filed: Jul. 27, 2009

Related U.S. Application Data
(60) Provisional application No. 61/084,347, filed on Jul. 29, 2008.

(51) Int. Cl. F03D 9/00; F03D 1/00

(52) U.S. Cl. 290/55; 415/220

(57) ABSTRACT

A turbine apparatus includes a specially shaped fan, designed to be inserted into the wheel of an automobile. During movement of the vehicle, the fan captures the passing air, and a axel/shaft transfers rotational energy to a generator that accumulates the energy and converts it to electrical energy. This energy may subsequently be used to reduce or eliminate emissions in automobiles, trucks, boats, planes, and the like.

### RELATED APPLICATIONS

The present application claims priority to provisional patent application U.S. Ser. No. 61/084,347 filed Jul. 29, 2008, which is incorporated by reference in its entirety herein.

### TECHNICAL FIELD

The present invention relates to a turbine apparatus for use with motors, generators, and the like. More specifically, the turbine apparatus is configured to gather energy from wind or water and convert the energy to electrical power.

### BACKGROUND INFORMATION

In the quest to find more energy-efficient vehicles, hybrid technology has exploded over the last 5 years. One area of hybrid technology involves the use of generator-assisted or charger-assisted mechanisms that gather renewable energy from the sun or wind, and utilize it to power or charge a vehicle. Examples of such vehicles are disclosed in U.S. Pat. No. 4,132,282, titled “Automotive Electric Generator” and U.S. Pat. No. 5,920,127, titled “Propeller Wind Charging System for Electrical Vehicle”, both of which are incorporated by reference in their entirety herein.

While such designs provide some energy assistance to vehicles and the like, the fan design is typically bulky and requires awkward and/or conspicuous placement of a fan on top of a vehicle. Additionally, these designs do not take full advantage of other areas of a vehicle that may provide additional gravitational and/or inertial energy. Accordingly, there is a need for a generator/charger fan and apparatus that improves the design and placement of fans while maximizing the potential for energy capture from renewable sources.

### SUMMARY

The present disclosure relates to a fan and generator/charger assembly that has a unique shape and placement that allows it to capture wind energy and assist in converting the wind energy into electrical energy. Also, the present invention provides the format for battery powered automotive vehicles. Power would come from the revolution of the wheels on the vehicle. Up to four or more wheels in trucks or other vehicles would have a fan in a wheel that would be in line with the wheel that the vehicle is being driven by. The inside wheel will contain a fan that would rotate as the vehicles wheels turn. That energy would be sent to a generator or alternator that would power electric storage batteries within the vehicle. This energy would be used to power the vehicle.

As such, a fully electric motor would be able to drive itself without relying extensively on gasoline or other fuel. It could propel itself without any emissions that are normal to a gas driven vehicle. The cost to consumers will be significantly less to operate the vehicle and there will be no pollution. The United States would save countless dollars that are being spent by consumers on gasoline. The health of Americans would not be compromised by fumes from gasoline.

Other objects, features, and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 discloses an exemplary air turbine fan under one exemplary embodiment.

FIG. 2 illustrates an automobile equipped with the air turbine fan disclosed in the embodiment of FIG. 1.

FIG. 3 illustrates an exemplary generator system utilizing the fan of FIG. 1.

FIG. 4 illustrates an exemplary vehicle system utilizing a DC motor system for powering a vehicle.

FIG. 5 illustrates an exemplary vehicle system utilizing a AC motor system for powering a vehicle.

### DETAILED DESCRIPTION

Under an exemplary embodiment, a motorized vehicle, such as an automobile, and even a truck, train or tractor, has a round housing or hub attached to the wheels. Inside the hub are fans that will turn from the rotation of the wheels. When the wheels turn the rotating fans inside the housing will produce electric energy. Under a preferred embodiment, a vehicle would have four sets of fans that collect energy that may subsequently be stored in tanks and/or set to alternators. Under an alternate embodiment, the fans may be coupled to a boat, where the energy would be collected from paddles (fans) that are in the water, where the paddles will push and create the energy that will be collected.

The tanks used to collect energy may also be in the form of compressed air or steam to be used as a form of energy to propel an engine or used as a means of creating energy to be stored in batteries. The system may be used as a combination of both air and battery power, and may also include the use of propellants, such as gasoline, hydrogen, ethanol, biofuel, or any combination thereof.

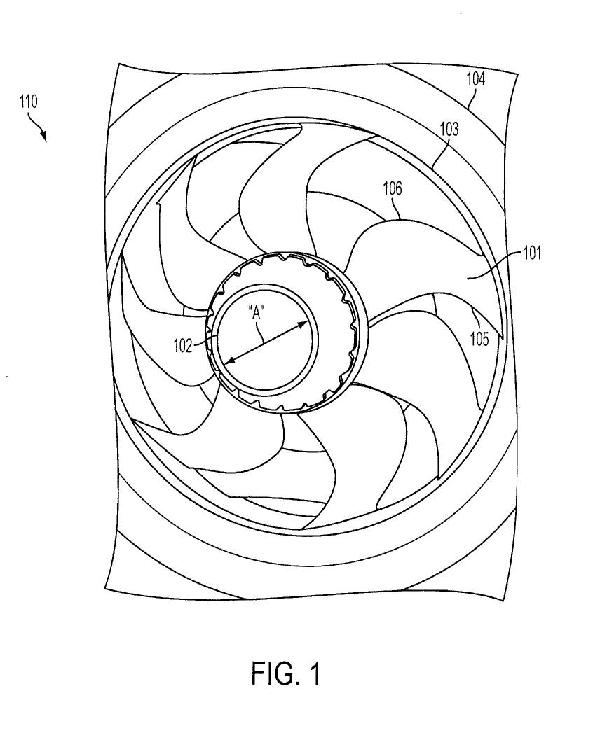

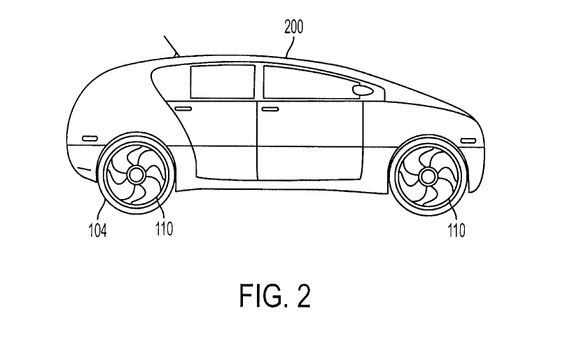

FIG. 1 discloses an exemplary wheel hub 110, positioned within wheel 104 of an automobile (see FIG. 2). Hub 110 comprises a plurality of fan blades 101 that extend radially from inner hub 102. Each of the fan blades are preferably shaped so that an inner portion of the blade 105 has a convex shape that extends a portion of the blade past a planar area defined by the front of hub 103. A back portion 106 of the fan blade preferably extends the blade to provide an elongated surface area that is particularly advantageous for capturing wind.

As illustrated in FIG. 1, one end of each fan blade 101 is affixed to outer hub 103. The other end of fan blade 101 is affixed to an inner hub 102. Under a preferred embodiment, inner hub 102 comprises a hollow interior for facilitating air movement (shown as arrow “A” in FIG. 1).

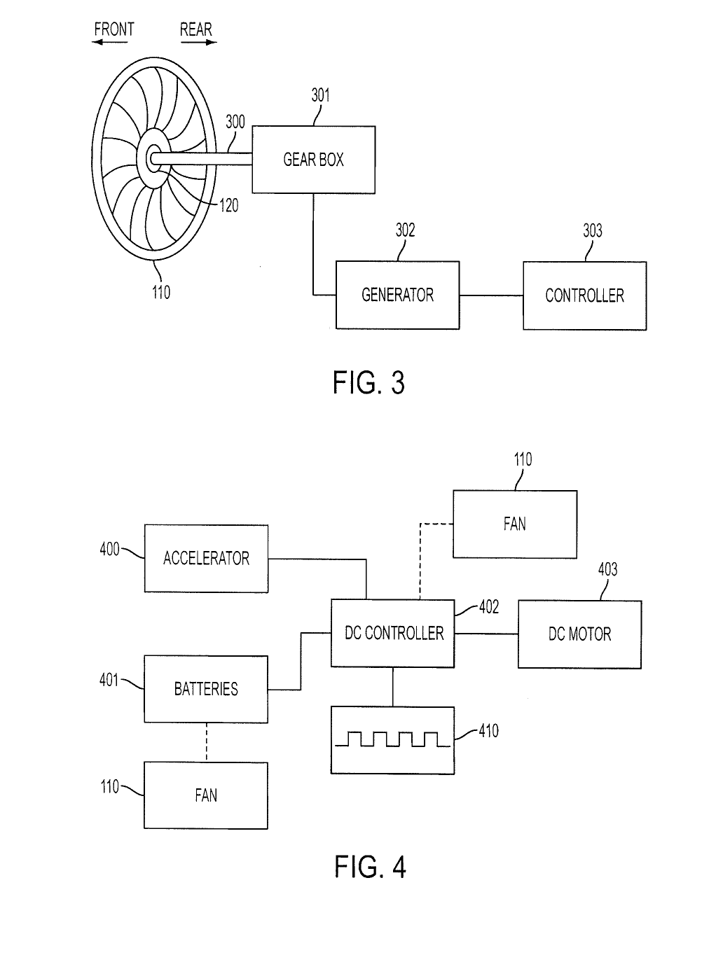

During operation, when a vehicle is in motion and/or accelerating, wind energy is collectively captured by fans 101 of hub 103. Additionally, the spinning of axel/shaft 300 (see FIG. 3) during movement of the vehicle exerts additional force on hub 110 which adds momentum. As can be seen in the illustration of FIG. 2, an automobile 200 would preferably have hubs 110 on both the front and back wheels on each side of the vehicle, for a total of 4 hubs.

Turning to FIG. 3, an exemplary system utilizing hub 110 is shown. To stabilize and allow independent rotation of hub 110, a sleeve 120 is preferably attached to the end of axel/shaft 300 at the rear of hub 110. Sleeve 120 is preferably equipped with bearings and slip gears (not shown) to allow the wheel to rotate in a given direction during movement of the vehicle, and after the vehicle has stopped.

Axel/shaft 300 is attached to a gear box 301, which serves to translate rotational energy from fan 110 to electrical generator 302. The specific ratio for gear box 301 is selected in accordance with amount of appropriate power that is required for the system. Electrical generator accumulates energy and provides it to controller 303, which then distributes the electrical energy to other areas of the system as needed.

Turning to FIG. 4, an exemplary DC-based vehicle system is disclosed that utilizes hub 110. DC controller 402 is arranged to take power from the batteries 401 and deliver it to the motor 403. Accelerator 400 is preferably arranged to provide a variable-power signal (via potentiometers, or variable resistors) to DC controller 402. This signal will determine for the DC controller how much power it is supposed to deliver for moving the vehicle. The controller may deliver zero power (when the vehicle is stopped), full power (when the accelerator is “floored”), or any power level in-between. Under an exemplary embodiment, when the accelerator is depressed by a user, the DC controller pulses the voltage (410) to create an average voltage that is subsequently passed to DC motor 403.

In FIG. 4, fan 110 may be arranged to provide energy to the DC controller 402 for distributing energy to motor 403. Alternately, fan 110 may provide charge to batteries 401, which in turn powers motor 403. In another embodiment, certain fans from the system may be directed to power controller 402, while other fans simultaneously provide charge to batteries 401.

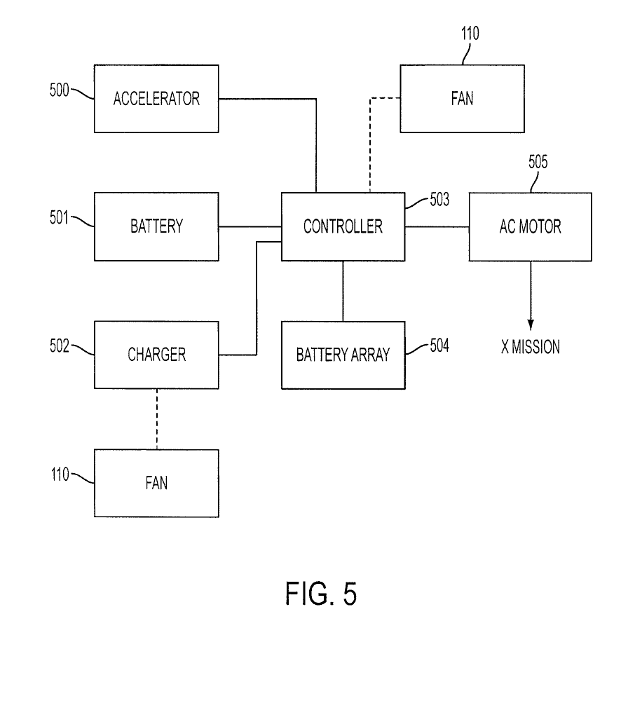

FIG. 5 illustrates an alternate embodiment, where an AC-based vehicle system utilizes hub 110. Just as in FIG. 4, accelerometer 500 signals AC controller 503 for establishing levels of power for moving a vehicle. In the exemplary embodiment, battery 501 and charger 502 provides energy to operate controller 503. Battery array 504 would be responsible for providing overall energy to AC motor 505, which would ultimately power the vehicle transmission.

As controller 503 is based on AC power, the controller would preferably operate by producing three pseudo-sine waves by taking the DC voltage from battery array 504 and pulsing it on and off. In an AC controller, there is the additional need to reverse the polarity of the voltage multiple times a second (e.g., 60 times per second). Thus, in a preferred embodiment, multiple (e.g., 6) transistors would be needed in the AC controller 503. For each phase, one set of transistors would be needed to pulse the voltage and another set to reverse the polarity.

In FIG. 5, fan 110 may be arranged to provide energy to the AC controller 503 for distributing energy from battery array 504 to motor 505. Alternately, fan 110 may provide charge to batteries 501 via charger 502, which in turn provides supplementary power to motor 505. In another embodiment, certain fans from the system may be directed to power controller 503, while other fans simultaneously provide charge to batteries 501.

Although the invention has been described with reference to particular arrangements and embodiments, these are not intended to exhaust all possible arrangements or embodiments, and indeed many other modifications and variations will be ascertainable to those of skill in the art. For example, while the embodiments discussed above relate to vehicles, the same principles described above are equally applicable to boats, planes or any other means of transportation. Also, while specific materials are mentioned in this document, one skilled in the art would appreciate that other materials may be used or substituted. This application covers any adaptations or variations of the present invention. Therefore, the present invention is limited only by the claims and all available equivalents.

What is claimed is:

1. A turbine apparatus, comprising:
an inner hub;
an outer hub, wherein the outer hub is configured to be inserted into a vehicle tire;
a plurality of fan blades connecting the inner hub to the outer hub, wherein each of said plurality of blades has at least a portion having a convex shape and wherein at least another portion has an elongated surface area; and
a sleeve, connected to a back area of the inner hub, to allow rotation of the inner hub.

2. The turbine apparatus of claim 1, wherein the inner hub has a hollow center.

3. The turbine apparatus of claim 1, further comprising a shaft having a first end coupled to the sleeve.

4. The turbine apparatus of claim 3, comprising a gear box coupled to a second end of the shaft.

5. The turbine apparatus of claim 4, comprising a generator coupled to the gear box.

6. The turbine apparatus of claim 5, comprising a controller coupled to the generator.

7. The turbine apparatus of claim 5, comprising a charger coupled to the generator.

8. The turbine apparatus of claim 5, wherein the generator provides power to a DC power system.

9. The turbine apparatus of claim 5, wherein the generator provides power to a AC power system.

10. A method for providing power to a vehicle, comprising:
capturing wind energy in a fan apparatus inserted in at least one wheel of the vehicle, said fan comprising an inner hub, an outer hub, a plurality of blades connecting the inner hub to the outer hub, wherein each of said plurality of blades has at least a portion having a convex shape and wherein at least another portion has an elongated area, and a sleeve connected to a back area of the inner hub, to allow rotation of the inner hub;
capturing energy from the rotation of the inner hub; and
transferring the captured wind energy and energy from the rotation of the inner hub to at least one of a charger and controller in said vehicle.

11. A turbine apparatus, comprising:
an inner hub and an outer hub, wherein the outer hub is configured to be inserted into a vehicle tire;
a plurality of fan blades connecting the inner hub to the outer hub, wherein each of said plurality of blades has at least a portion having a convex shape extending a portion of the blade past a planar area defined by the front of the outer hub and wherein at least another portion of said blade has an elongated surface area; and
a sleeve, connected to a back area of the inner hub, to allow rotation of the inner hub caused by the fan.

12. The turbine apparatus of claim 11, wherein the inner hub has a hollow center.

13. The turbine apparatus of claim 11, further comprising a shaft having a first end coupled to the sleeve.

14. The turbine apparatus of claim 13, comprising a gear box coupled to a second end of the shaft.

15. The turbine apparatus of claim 14, comprising a generator coupled to the gear box.

16. The turbine apparatus of claim 15, comprising a controller coupled to the generator.

17. The turbine apparatus of claim 16, comprising a charger coupled to the generator.

18. The turbine apparatus of claim 16, wherein the generator provides power to a DC power system.

19. The turbine apparatus of claim 16, wherein the generator provides power to a AC power system.
